(19) United States
(12) Patent Application Publication
(10) Pub. No.: US 2017/0075331 A1
(43) Pub. Date: Mar. 16, 2017

(54) APPARATUS, SYSTEM, AND METHOD FOR CONFIGURING AND PROGRAMMING CONTROL OF A ROBOT

(71) Applicant: Yaskawa America, Inc., Waukegan, IL (US)

(72) Inventors: Chetan KAPOOR, Austin, TX (US); Peter S. MARCH, Austin, TX (US)

(73) Assignee: Yaskawa America, Inc., Waukegan, IL (US)

(21) Appl. No.: 15/260,347

(22) Filed: Sep. 9, 2016

Related U.S. Application Data
(60) Provisional application No. 62/217,074, filed on Sep. 11, 2015.

(51) Int. Cl. G05B 19/042; G05B 19/05

(52) U.S. Cl. CPC G05B 19/0426; G05B 19/056; G05B 2219/40419

(57) ABSTRACT

A programmable logic controller controls at least one robot to manipulate a plurality of workpieces. The programmable logic controller includes a sensor interface configured to receive sensor data that represents information of the workpieces. The programmable logic controller includes a scheduler configured to create a schedule that includes information representing an order in which the workpieces are to be manipulated. The schedule created by the scheduler is based on the sensor data. The programmable logic controller includes a synchronizer that is configured to receive the schedule. The synchronizer is configured to cause a robot to manipulate the workpieces based on the schedule and based on a function block. The function block is configured via the programmable logic controller.

### CROSS-REFERENCE TO RELATED APPLICATION

The present application claims priority under 35 U.S.C. §119 to U.S. Provisional Application No. 62/217,074, filed on Sep. 11, 2015, the entire contents of which are herein incorporated by reference.

### BACKGROUND OF THE INVENTION

Field of the Invention

The present invention relates to a controller used in conjunction with one or more robots and used to program the one or more robots to carry out a particular task.

Discussion of the Background

Robotic automation has improved the speed, reliability, and cost associated with a variety of manufacturing processes. However, programming the operation of manufacturing robotics is a time-consuming and difficult process that requires extensive training and expense. Programming can be difficult to modify, and can require configuration of multiple devices, each involving different programming languages, interfaces, and communication systems.

WO 2012/097835 A2 describes the provision of coordinates of a movement path by a programmable logic controller. WO 2013/013686 A1 describes a system for commanding a robot characterized in that a command queue is foreseen to keep at least the lastly executed robot command within its memory.

### SUMMARY OF THE INVENTION

The present invention advantageously provides a programmable logic controller that controls a robot to manipulate a plurality of workpieces. The programmable logic controller includes a sensor interface configured to receive sensor data that represents information of the workpieces. The programmable logic controller includes a scheduler that is configured to create a schedule that includes information representing an order in which the workpieces are to be manipulated. The schedule created by the scheduler is based on the sensor data. The programmable logic controller also includes a synchronizer that is configured to receive the schedule. The synchronizer is configured to cause the robot to manipulate the workpieces based on the schedule and based on at least one function block. The at least one function block is configured via the programmable logic controller.

The present invention advantageously provides a programmable logic controller for controlling at least one robot to manipulate a plurality of workpieces. The programmable logic controller comprises circuitry configured to receive sensor data representing information of a plurality of workpieces to be manipulated by a robot. The circuitry is also configured to create a schedule that includes information representing an order in which the workpieces are to be manipulated based on the sensor data. The circuitry is also configured to receive a schedule and thereafter control the robot to manipulate the workpieces based on the schedule and at least one function block, the at least one function block being configured with the programmable logic controller.

The present invention also advantageously provides a system for manipulating a plurality of workpieces. The system comprises a sensor, a first robot, a second robot, and a programmable logic controller for controlling the first robot and the second robot. The programmable logic controller includes a sensor interface configured to receive sensor data from the sensor representing location information of the workpieces. The programmable logic controller includes a scheduler configured to create a schedule including information representing an order in which the workpieces are to be manipulated based on the sensor data. The programmable logic controller also includes a synchronizer configured to cause at least one of the first robot and the second robot to manipulate the workpieces based on the schedule and at least one function block, the at least one function block being configured with the programmable logic controller.

The present invention also advantageously provides a method of controlling at least one robot to manipulate a plurality of workpieces with a programmable logic controller. The method comprises receiving sensor data representing location information of the workpieces. The method also comprises creating a schedule including information representing an order in which the workpieces are to be manipulated based on the sensor data. Also, the method comprises controlling a robot to manipulate the workpieces based on the schedule and at least one function block, the at least one function block being configured with the programmable logic controller.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 is a partial schematic view of a programmable logic controller and associated components of a system according to an embodiment of the present invention;

FIG. 2 is a block diagram illustrating features of the programmable logic controller according to an embodiment of the present invention;

FIG. 3 is a block diagram illustrating functionality of the sensor interface and pick scheduler according to an embodiment of the present invention;

FIG. 4 illustrates an exemplary representation of raw data obtained by a sensor,

FIGS. 5A-5C illustrate exemplary robot assignments for a plurality of workpieces;

FIG. 6 illustrates a perspective partial schematic view of a system for configuring operation of a plurality of robots according to an embodiment of the present invention;

FIG. 7 illustrates exemplary function blocks according to an embodiment of the present invention;

FIG. 8 is a flowchart illustrating an exemplary process for configuring and programming robot operations to manipulate a plurality of workpieces according to an embodiment of the present invention;

FIG. 9 is a flowchart illustrating an exemplary process for configuring and programming robot operations to manipulate a plurality of workpieces when a plurality of robots operate in a cooperative manner according to an embodiment of the present invention;

FIG. 10 is a perspective view of a system for configuring and programming robot operations to manipulate a plurality of workpieces when multiple workpiece suppliers are employed; and

FIG. 11 is a flowchart illustrating an exemplary process for configuring and programming a robot according to an embodiment of the present invention.

### DETAILED DESCRIPTION OF EXEMPLARY EMBODIMENTS OF THE INVENTION

Embodiments of the present invention will be described hereinafter with reference to the accompanying drawings. In the following description, the constituent elements having substantially the same function and arrangement are denoted by the same reference numerals, and repetitive descriptions will be made only when necessary.

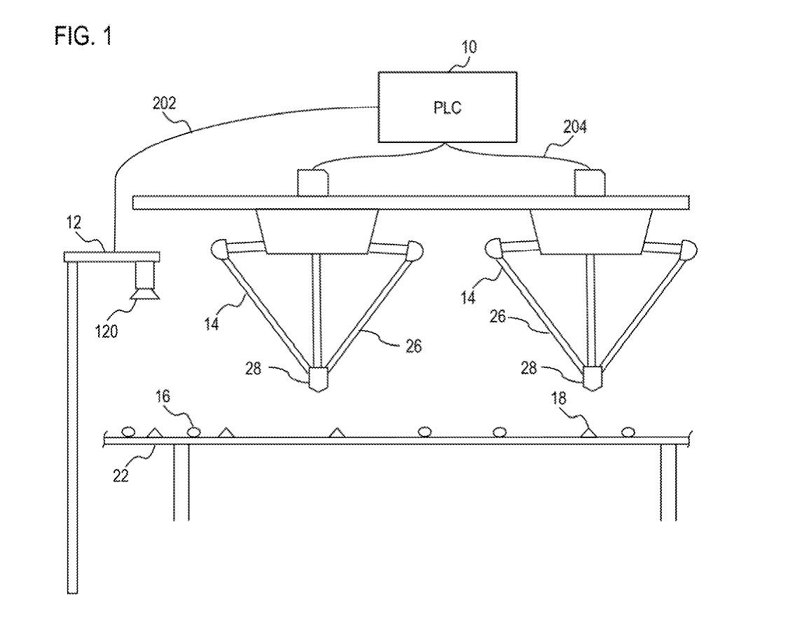

A configuration of a programmable logic controller (PLC) 10 according to an exemplary embodiment of the invention will be described with reference to FIG. 1. FIG. 1 is a front partial schematic view illustrating PLC 10 and associated components that together comprise a system according to an embodiment of the present invention.

As illustrated in FIG. 1, the PLC 10 is in communication with a sensor 12 and one or more robots 14. The PLC communicates with the sensor 12 via communication bus 202. The PLC 10 directly or indirectly controls the operation of robots 14 along communication path 204, as will be described in further detail below. Robots 14 are provided to manipulate workpieces 16 and 18, which are located on a workpiece supplier 22. Each robot 14 includes at least one arm 26 to position an end effector 28. The end effector 28 is operable to manipulate the workpieces 16, 18. The workpiece supplier 22 can be a device for transporting workpieces 16, 18 such as a conveyor, and can be an infeed or outfeed device. Thus, the workpiece supplier transports the workpieces 16, 18 to a working range of the robots 14. The workpiece supplier 22 can alternatively be a table, bin, or any type of surface that provides workpieces 16, 18 without motion.

The position of the workpieces 16, 18 on workpiece supplier 22 is determined with the use of at least one sensor 12, which can include a camera 120. Camera 120 tracks the position of workpieces 16, 18 as they move according to motion imparted by workpiece supplier 22. Camera 120 tracks the location of stationary workpieces 16, 18, and updates the positions of the workpieces 16, 18 as workpieces are manipulated by a robot 14. The PLC 10 can also receive information regarding the position and speed of the workpiece supplier 22 via an encoder or similar device.

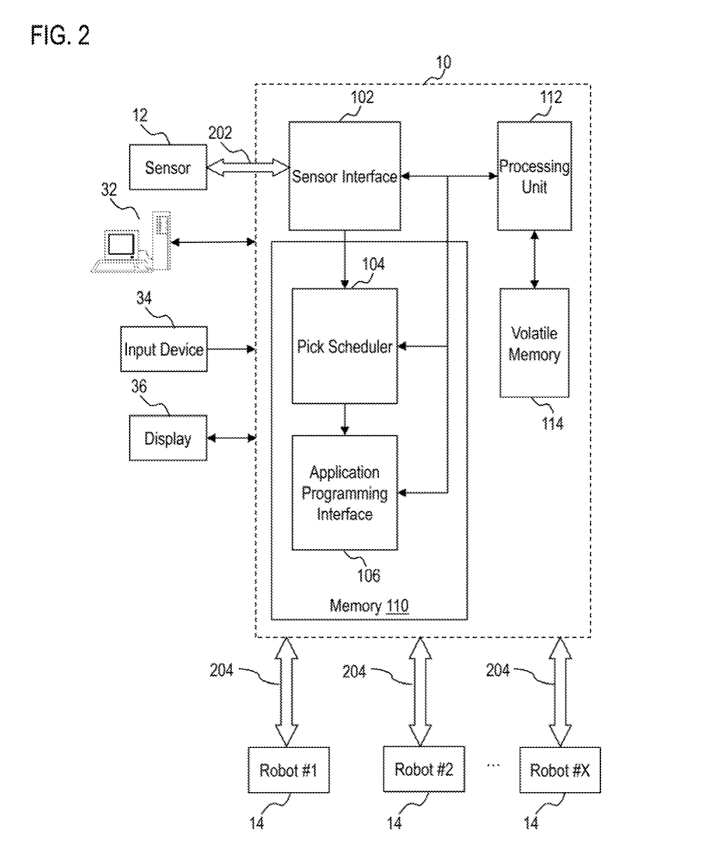

FIG. 2 is a block diagram illustrating an exemplary configuration of the programmable logic controller 10. As illustrated in FIG. 2, the programmable logic controller 10 includes a sensor interface 102, a memory 110, a processing unit 112, and a volatile memory 114. Memory 110 is a non-volatile memory such as a flash memory, a hard drive, or read-only memory. Memory 110 can be permanently installed in PLC 10 or be removable, the example when memory 110 is implemented by a flash memory that is connected via a universal serial bus. Volatile memory 114 can be formed by a random access memory or can be included in memory 110.

The pick scheduler 104 and application programming interface 106 can be stored in memory 110. The pick scheduler 104 and the application programming interface 106 can be software programs executed by the processing unit 112. Thus the pick scheduler 104 and the application programming interface 106 and can be stored together as an application, or independently as separate applications in memory 110.

The processing unit 112 accesses memory 110 in order to execute the pick scheduler 104 and application programming interface 106. Processing unit 112 is a processing device such as a microprocessor that executes the pick scheduler 104 and the application programming interface 106. Volatile memory 114 is employed by the PLC 10 to temporarily store information prior to and during the operation of the pick scheduler 104 and the application programming interface 106. The volatile memory 114 can store raw data or parsed data that is received by the sensor interface 102 as well as other information necessary for the operation of the pick scheduler 104 and the application programming interface 106.

The PLC 10 is configurable by a user via at least one of a personal computer 32, an input device 34, and a display 36. These components each allow a user to program or configure the detailed operation of the pick scheduler 104 and the application programming interface 106, including interacting with function blocks.

The personal computer 32 is connected to the PLC 10 via an Ethernet connection or wireless network, for example. This allows a user to control the operation of a robot 14 by interacting with the PLC 10 itself, without programming or configuring additional devices such as a motion controller. Thus, control of detailed operation of one or more robots can be accomplished by configuring the PLC 10 with a personal computer 32.

Input device 34 is a human interface device that allows direct interaction with PLC 10. For example, input device 34 can be a pendant that is used to independently configure PLC 10 either by wired or wireless connection. Input device 34 can also constitute a mouse and/or keyboard. Thus, the input device 34 can be used in place of the personal computer 32 to configure the PLC 10 and modify the operation of the pick scheduler 104 and the application programming interface 106.

Display 36 is a display device that visually presents information to a user of PLC 10. The display 36 can include a touch interface and form a human interface device to allow a user to interact with pick scheduler 104 and application programming interface 106 and thus can be used to configure PLC 10 without the use of another device and either by wired or wireless connection.

Thus, by configuring the PLC 10 with a personal computer 32, input device 34, and/or display 36, the PLC 10 is operable to control the motion of at least one robot 14. In one embodiment, the PLC 10 controls a plurality of robots 14 along communication path 204. The PLC 10 is also capable of communicating with one or more additional PLCs 10, each of which is operable to control at least one corresponding robot 14. Thus, the PLC 10 can be employed in a complex environment utilizing a large number of robots 14. As illustrated in FIG. 2, PLC 10 communicates with a plurality of robots 14 represented by X such that the PLC controls robot #1, robot #2, and a number of additional robots. Communication can be achieved by communication path 204, which is a wired or wireless connection. The communication between the PLC 10 and each of the robots can be direct, as illustrated in FIGS. 1 and 2. To facilitate communication as illustrated in FIG. 2, each robot 14 can include an internal processing unit that generates control signals to control one or more motors of robot 14. In an embodiment of the invention, an intermediate component such as a motion controller receives control signals from PLC 10. The intermediate motion controller then provides particular motion commands to one or more robot 14. Alternatively, processing unit 112 or a second processing unit provided within PLC 10 can generate motion commands for individual motors of each robot 14 based on the operation of the pick scheduler 104 and application programming interface 106. Thus, control of the robots 14 by the PLC 10 can be direct or indirect. Also, the communication between the PLC 10 and the robots 14 and between the PLC 10 and an intermediate motion controller can be wireless.

As illustrated in FIG. 2, sensor interface 102 communicates with the sensor 12 via sensor communication bus 202. The sensor 12 provides raw data to sensor interface 102 representing workpiece information of sensed workpieces, such as workpieces 16, 18. This information can represent any combination of position information, shape information, color information, identification information, or other useful information of each individual workpiece 16, 18. The sensor 12 can be in the form of a vision sensor such as camera 120 that detects the location of workpieces 16, 18. Camera 120 detects the location and orientation for each workpiece. Sensor 12 and camera 120 can also communicate a relative measure of the quality of the location and/or orientation data obtained as a score. Sensor interface 102 of PLC 10 is an example of circuitry that receives sensor data representing information of workpieces 16, 18, which are to be manipulated by a robot 14.

Alternatively or in addition to a vision-based sensor 12 including a camera 120, sensor 12 can include a barcode reader, a height sensor, a distance detector that employs a laser, or other detectors that are useful in providing information for each of workpieces 16, 18.

The information captured by sensor 12 is transmitted to sensor interface 102 via sensor communication bus 202, which is a physical connection such as Ethernet cable, coaxial cable, universal serial bus cable. Alternatively, sensor communication bus 202 can be a wireless connection that provides communication between sensor 12 and sensor interface 102.

With reference to FIG. 1, the camera 120 or other sensors can also acquire information that identities the type of workpiece for each of the individual workpieces present. For example, FIG. 1 depicts two exemplary types of workpieces 16, 18 on workpiece supplier 22. In FIG. 1, the first type of workpiece, workpiece 16, has a different shape than the second type of workpiece, workpiece 18. These different shapes are identified by the sensor 12 which communicates the difference between the workpieces 16, 18 via the sensor communication bus 202. The sensor 12 can also identify and communicate the color, size, height, or information contained on a barcode for each of the workpieces 16, 18 in order to differentiate different types of workpieces. Although two types of workpieces are illustrated in FIG. 1, any number of different types of workpieces can be identified by sensor 12.

Returning to FIG. 2, sensor interface 102 receives the workpiece information as raw data. This raw data is communicated by the sensor interface 102 to the pick scheduler 104.

The pick scheduler 104 accepts and processes the raw data from sensor interface 102 that includes information of the workpieces 16, 18. One function of the pick scheduler 104 is to parse the raw data in order to determine, for example, the positions of each individual workpiece 16, 18. Parsing the raw data includes determining the coordinates of each of the workpieces on a common coordinate system, determining the angle or orientation of each workpiece, and removing any workpieces that includes a score value that is below a threshold or diverges in some way from the other workpieces. The parsing performed by the pick scheduler 104 can also include identifying and removing duplicates from the raw data that occur when a single workpiece 16, 18 is identified more than once. Thus, a workpiecce 16, 18 is not detected twice in two subsequent packets of data from the sensor interface 102.

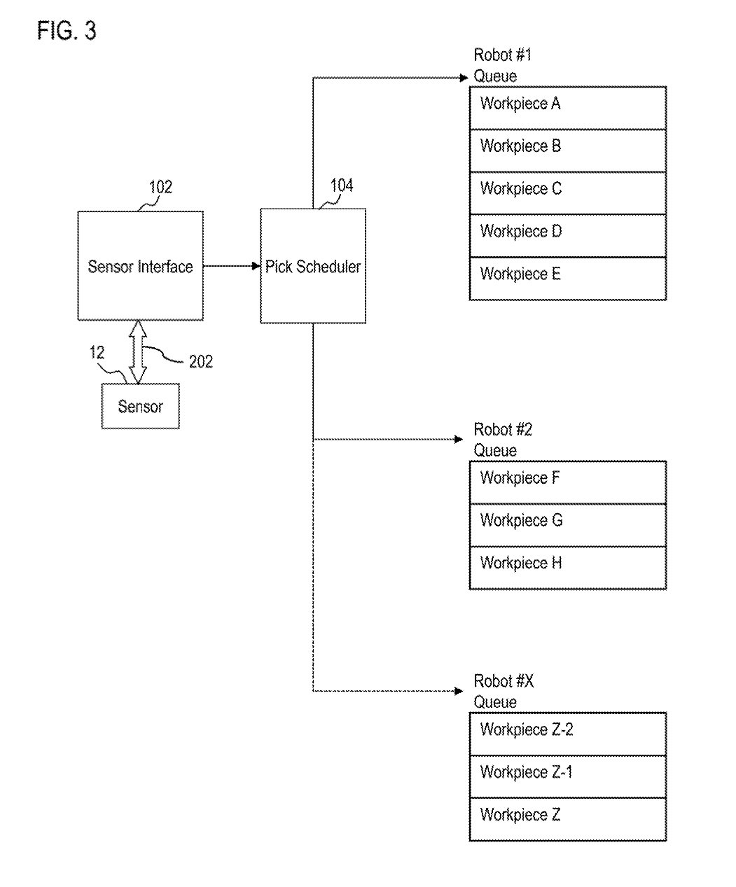

Queuing performed by pick scheduler 104 will be described with reference to FIG. 3. FIG. 3 illustrates exemplary queues for robot #1, robot #2, and robot #X, which correspond to the similarly-identified robots of FIG. 2. As illustrated in FIGS. 2 and 3, the sensor 12 communicates with the sensor interface 102 via the sensor communication bus 202. In turn, sensor interface 102 provides raw data to the pick scheduler 104. The pick scheduler 104 first parses the raw data and removes any duplicates present in the raw data, as described previously. The pick scheduler 104 then assigns a robot 14 to individual workpieces of the workpieces 16, 18. This assignment can be performed by creating a queue for each robot 14. A queue represents an order, or sequence, in which the individual robot 14 will manipulate the individual workpieces. The assignment of the workpieces 16, 18 to a particular robot 14 can be performed according to other criteria. For example, assignment of workpieces 16, 18 can be performed according to product type queuing or custom queuing. FIG. 3 illustrates exemplary queuing in which each robot 14 is assigned a series of workpieces by pick scheduler 104. The robots 14 are controlled to manipulate each workpiece in the order specified by the respective queues. The queue for each robot is thus an example of a schedule that includes information representing an order in which the workpieces are to be manipulated. The pick scheduler 104 stored in memory 110 is an example of circuitry that creates respective schedules for one or more robots 14 that includes information representing an order in which workpieces 16, 18 are to be manipulated based on the sensor data.

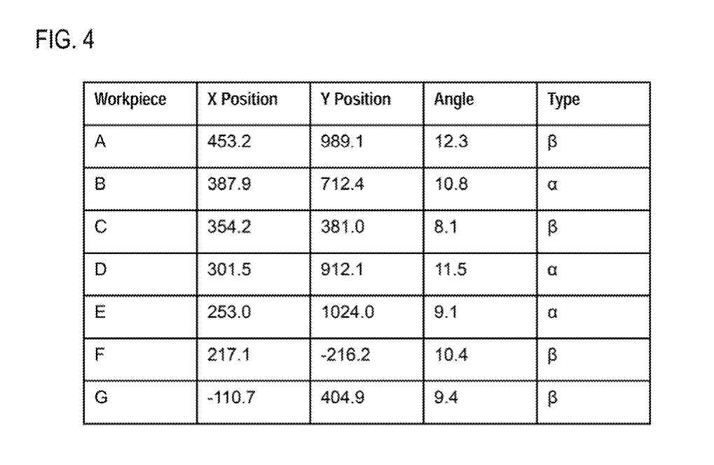

FIG. 4 is an exemplary representation of raw data received by the pick scheduler 104. FIG. 4 illustrates data for seven workpieces, workpieces A-G, which are examples of individual workpieces corresponding to workpieces 16 and 18. As illustrated in FIG. 4, workpiece information can represent the position of each workpiece in an X-direction and a Y-direction in a common coordinate system. Similarly, the workpiece information can represent a Z-direction position. The workpiece information can include information that represents an angle or orientation of each workpiece 16, 18. The workpiece information can also be useful to identify the type of workpiece 16, 18. FIG. 4 provides an example in which two types of workpieces are identified, type α and type β. In FIG. 4, type α corresponds to workpiece 16 and type β corresponds to workpiece 18. The different types of workpieces can represent different parts, different assemblies, different sizes, different colors, or other attributes that differentiate the workpieces of type α from the workpiece of type β.

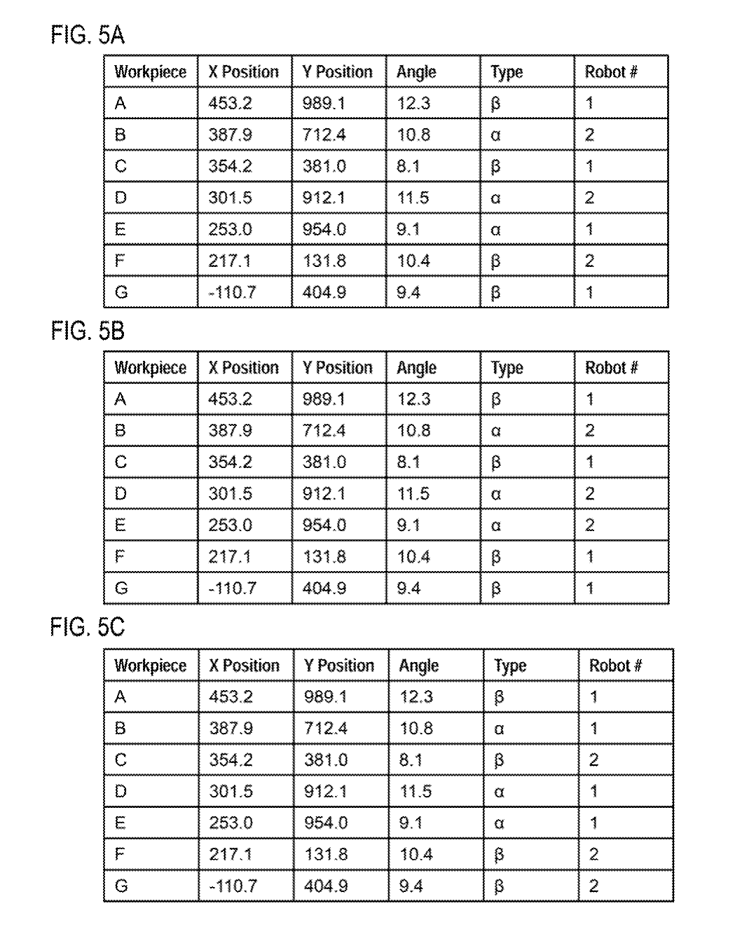

FIGS. 5A to 5C are exemplary representations of robot assignments performed by pick scheduler 104. The robot assignments can be performed according to different queuing methodologies, examples of which are described in detail below.

Sequential queuing is illustrated in the exemplary robot assignment provided in FIG. 5A. FIG. 5A illustrates exemplary assignments for workpieces A-G in a system employing two robots 14, robot #1 and robot #2. The workpieces in FIG. 5A are arranged in order, such that workpiece A is first in sequence, and workpiece G is last according to the X position along workpiece supplier 22. Sequential queuing is performed by assigning each workpiece to robot #1 and robot #2 in an alternating sequence such that each robot is assigned to every other workpiece. This type of sequencing can be used with more than two robots, thus improving efficiency. Other sequences are possible. For example, sequential queuing can be based on the position of each workpiece in the Y direction, or the angle or orientation of the workpiece. Thus, sequential queueing provides the ability to generate a queue of workpieces 16, 18 for robot 14 based on a set sequence or pattern.

Turning to FIG. 5B, product type queuing will be described. In product type queuing, a queue for each robot 14 is constructed by assigning one or more types of workpieces to a particular robot 14. In the example depicted in FIG. 5B, robot #1 is assigned to workpiece type β, while robot #2 is assigned to workpiece type α. It is also possible to assign a single robot to multiple types of workpieces. For example, a first robot #1 can be assigned to three types of workpieces (e.g., types α, β, and γ), while a second robot #2 can be assigned to one type of workpiece (e.g., type δ). More than two robots can be used. Any combination of robots and workpiece types can be employed with product type queuing. Product type queuing is particularly advantageous when multiple robots with different capabilities are present. With product type queuing it is possible to ensure that a particular robot is assigned only to suitable workpieces, by interacting only with PLC 10.

FIG. 5C illustrates an example of a custom queue. In FIG. 5C, each workpiece has a particular Y position. The Y position can represent, for example, a direction that is perpendicular to a motion direction of a workpiece supplier 22, thus forming a width of the workpiece supplier 22. In an example of custom queuing, two robots #1 and #2 can be used to manipulate workpieces based on the Y position of each respective workpiece. In the example of FIG. 5C, each workpiece with a Y position value of greater than 500 is assigned to robot #1 while each workpiece with a Y position value of less than 500 is assigned to robot #2. Thus, each robot can be assigned to workpieces in a manner the reduces the motion required in each manipulation, for example, by assigning a robot to a particular area of workpiece supplier 22.

Other types of custom queuing are also possible. Custom queuing allows a user to determine how the pick scheduler 104 assigns the respective workpieces to one or more robots according to any data that is obtained by the sensor interface 102. Thus, custom queuing provides a flexible means for configuring the PLC 10 without the need for in-depth programming knowledge. Any of the above-described queuing methods of FIGS. 5A-5C can be modified by a user by configuring and interacting with the PLC 10 with personal computer 32, input device 34, and/or display 36.

Advantageously, each of the above-described queuing methods, sequential queuing, product type queuing, and custom queuing, requires interaction only with the PLC 10. Thus, there is no need for programming a robot controller, a motion controller, or another processing device located between the PLC 10 and a robot 14.

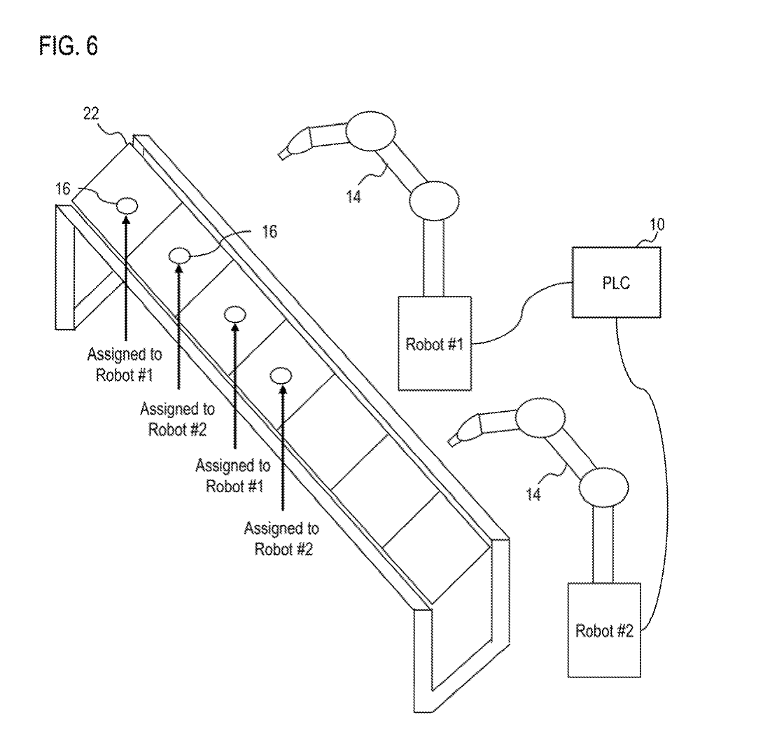

FIG. 6 is a perspective partial schematic view of an operation of the pick scheduler 104 of PLC 10 in which sequential queuing is performed. As illustrated in FIG. 6, two robots 14, robot #1 and robot #2, are controlled by PLC 10. A workpiece supplier 22 in the form of a conveyor supplies workpieces 16 to the robots 14. Although only one type of workpiece 16 is illustrated in FIG. 6, a plurality of types of workpieces 16, 18 could be provided by workpiece supplier 22. The PLC 10, via the pick scheduler 104, provides a queue for robot #1 and robot #2. FIG. 6 illustrates an exemplary configuration of sequential queuing akin to FIG. 5A, in which each robot 14 is assigned to every other workpiece 16. Thus, the work is split evenly between robot #1 and robot #2. However, the pick scheduler 104 could create queues with uneven or asymmetric work distributions. For example, robot #1 could be assigned to 75% of the workpieces while the remaining 25% are placed in the queue for robot #2.

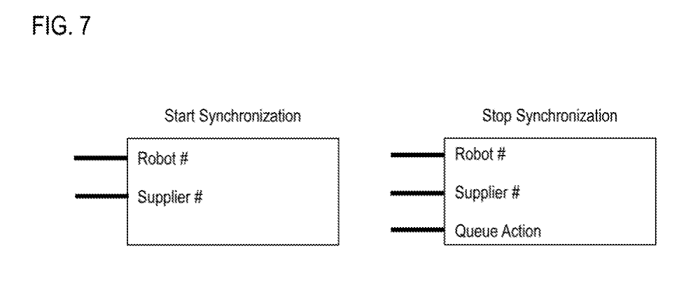

Details of the application programming interface 106 will now be described with reference to FIG. 7. The application programming interface 106 includes function blocks that allow interaction with the queue or queues created by the pick scheduler 104. The application programming interface 106 can receive the queues from pick scheduler 104. The programming interface 106 stored in memory 110 and executed by processing unit 112 is an example of circuitry configured to receive a schedule and thereafter control a robot 14 to manipulate workpieces 16, 18 based on the schedule and at least one function block, the at least one function block being configured with the PLC 10. Two exemplary function blocks are illustrated in FIG. 7 and will be descried in detail below.

As illustrated in FIG. 7, the application programming interface 106 can include a start synchronization function block. This function block waits until a workpiece in a respective robot's queue is located in a specified start position. The start position is, for example, a predetermined distance from robot 14 on workpiece supplier 22. Once the start synchronization function block has started, any motions will include a displacement of the workpiece supplier 22, if present. Thus, the start synchronization function block allows for accurate motion command of a robot 14 when a workpiece 16, 18 is in motion along workpiece supplier 22. The start synchronization function block also checks a maximum allowed position of the workpiece. The maximum allowed position can represent, for example, a maximum distance at which a robot 14 can access a workpiece 16, 18. Thus, the start synchronization function block will prevent a robot 14 from attempting to access a workpiece 16, 18 that is outside of a maximum operating distance, or will be outside the maximum operating distance before the robot 14 is able to access the workpiece 16, 18.

The start synchronization function block can allow a user to identify a particular robot 14 and a particular workpiece supplier 22. Thus, the application programming interface 106 allows a user to control how a particular robot 14 interacts with a given workpiece supplier 22. This function is advantageous when multiple robots 14 and multiple workpiece suppliers 22 are present. The start synchronization function block allows simplified programming of a robot 14 to operate in conjunction with a workpiece supplier 22 that provides a plurality of workpieces 16, 18 by imparting the workpieces 16, 18 with motion.

With continued reference to FIG. 7, the application programming interface 106 can also include a stop conveyor synchronization function block. The stop synchronization function block can be used, for example, to terminate a tracking operation of a robot 14 that was initialized by the start synchronization function block. The stop synchronization function block also allows a user to interact with one or more queues generated by pick scheduler 104. The stop synchronization function block can allow removal of a particular one of the workpieces 16, 18 from the queue of one or more of the robots 14. This function block can also provide a mechanism for specifying that a particular workpiece 16, 18 should be kept in a particular robot's queue. Additionally, the stop synchronization function can operate to move one or more workpieces 16, 18 from the queue of one of the robots 14 to the queue of another one of the robots 14.

As illustrated in FIG. 7, the stop synchronization function block allows a user to identify a particular robot 14 as well as a particular workpiece supplier 22. Further, the stop synchronization function block allows a user to define a modification that is performed on a queue for a robot 14. For example, the stop synchronization function block can allow a user to specify that a robot 14 stops synchronization with a particular workpiece 16, 18 after moving the workpiece 16, 18 to a destination position. The workpiece 16, 18 can then be removed from the queue of the robot 14, or added to the queue of another robot 14 that subsequently performs work on the workpiece 16, 18. Alternatively, the stop synchronization function block can be used to stop synchronization when a workpiece 16, 18 is located outside of the workable range of a particular robot, and move the workpiece 16, 18 to the queue of another robot 14.

In addition to the start synchronization and stop synchronization function blocks, the application programming interface can also include a variety of other function blocks. For example, motion blocks that provide predetermined motions for a robot can be included. These motion blocks can include basic motions that, when used with the pick scheduler 104, allow for the manipulation of workpieces 16, 18 that enter the queue of a particular robot 14. The use of motion blocks provide for robot 14 actions such as moving to a wait position, picking a workpiece, assembling or combining a plurality of workpieces, moving to a placement position, and releasing a workpiece. Other function blocks with various motions and manipulations can be employed in the application programming interface 106. Each function block can be configured by use of the personal computer 32, input device 34, and/or display 36.

The above-described function blocks of the application programming interface 106 can be employed in concert with the pick scheduler 104 to control robots 14 in a variety of scenarios of various complexity. The start synchronization function block is employed to provide accurate tracking of a particular workpiece 16, 18 that is in motion along workpiece supplier 22. The start synchronization function block also controls a robot 14 to wait until a workpiece 16, 18 in the queue of the robot 14 is within a working range of the robot 14. Once this workpiece 16, 18 is manipulated or found to be out of range of a robot 14, the stop synchronization function block can then remove the workpiece 16, 18 from the queue, and place the workpiece 16, 18 on the queue for a different robot 14.

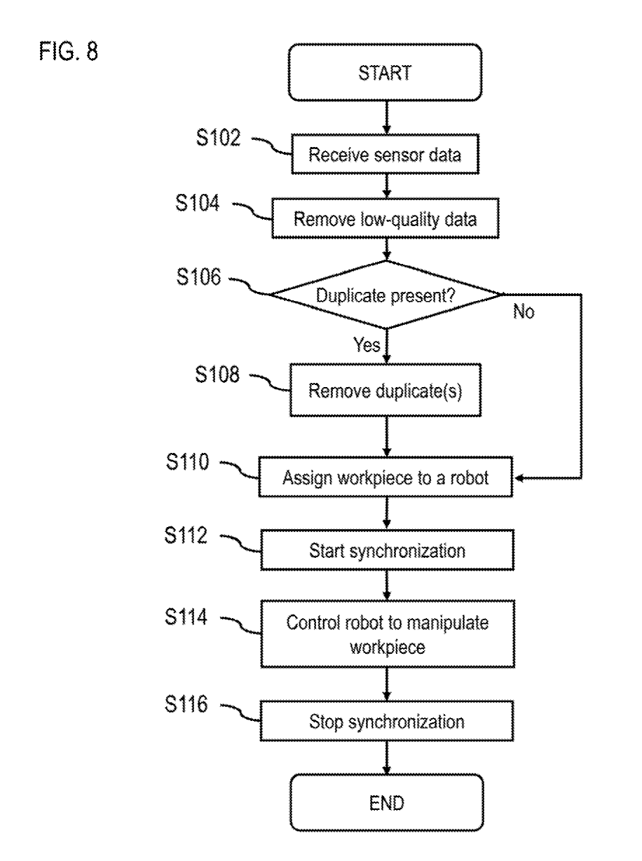

One exemplary scenario in which sensor interface 102, pick scheduler 104, and application programming interface 106 are used to control one or more robots 14 to manipulate a workpiece 16, 18 will now be described with reference to FIG. 8.

FIG. 8 provides a flowchart for a process of configuring and programming robotic operations according to an embodiment of the present invention. As illustrated in FIG. 8, a program structure for a manipulation operation can be constructed using the pick scheduler 104 and application programming interface 106. At step S102, sensor data is received by the sensor interface 102. Step S102 is an example of receiving sensor data representing location information of workpieces 16, 18. The sensor data is passed as raw data to pick scheduler 104. Pick scheduler 104 parses the sensor data in steps S104, S106, and S108. Step S104 removes low-quality data. This can be performed by removing data that falls below a quality threshold. For example, quality data obtained as a score by sensor 12 is compared to a predetermined quality threshold. If the score is a value less than the predetermined quality threshold, the workpiece 16, 18 corresponding to the score is determined to be defective, obscured, or misidentified, and is removed. In step S106, the presence of any duplicate is determined. This can be performed by comparing the raw data of a current scan with the raw data of a previous scan. If a duplicate is identified, the process proceeds to step S108 in which any identified duplicates are removed. If no duplicate is present, the process proceeds immediately to step S110.

After data is parsed in steps S104, S106, and S108, the process proceeds to step S110 in which one or more workpieces 16, 18 are assigned to one or more of the robots. Step S110 is performed by the pick scheduler 104 to generate one or more queues as illustrated in FIG. 3. When multiple robots 14 are present, step S110 is performed by creating respective queues for each of the plurality of robots 14. Step S110 can be performed by a user interacting with PLC 10 to configure the pick scheduler 104. Step S110 can be performed according to the sequential queuing, product type queuing, custom queuing, or a combination thereof, as discussed previously. Each of these queuing types can be selected or customized by a user in order to achieve a desired operation of the PLC 10. Also, each of these queueing types can be employed to create a respective queue for each robot 14. The pick scheduler 104 can perform a desired queueing methodology for each robot 14. Step S110 can also include manual manipulation of a product in a queue by a user. Step S110 is an example of creating a schedule including information representing an order in which the workpieces are to be manipulated based on the sensor data.

Once at least one workpiece is placed in a queue and is thereby assigned to a robot 14 in step S110, the function blocks corresponding to the application programming interface 106 operate to control the motion of a robot 14 with respect to the workpiece 16, 18 in the queue. Prior to or during the operation of PLC 10, a start synchronization function block can be presented to a user. Thus, step S112 is performed by the PLC 10 in accordance with the application programming interface 106 of the PLC 10, as configured by a user. In step S112, a robot 14 is controlled to begin tracking a first workpiece 16, 18 in the queue of a robot 14. Step S112 can include waiting until a workpiece 16, 18 is located within a working range of a robot 14. The synchronization performed with the start synchronization can be configured by a user to achieve a desired behavior of robot 14.

In step S114, the PLC 10, controls a robot 14 to manipulate the first workpiece 16, 18 in the queue of a robot 14 according to the application programming interface 106. This manipulation can be performed taking into account an offset that is determined by the start synchronization function block when workpiece supplier 22 operates to provide motion to workpieces 16, 18 over time. The manipulation in step S114 can also be performed by the PLC 10 while taking into account other configurations made by a user to the start synchronization function block. Additionally, step S114 can be performed by the PLC 10 based on any other function block configured by the user, including function blocks that define desired motions of the robot 14. Thus, step S114 is an example of controlling robot 14 to manipulate workpieces 16, 18 based on the schedule and at least one function block, the at least one function block being configured with the programmable logic controller. When multiple robots 14 are present, S114 involves controlling a plurality of robots 14 according to their respective queues.

In step S116, once a workpiece 16, 18 has been manipulated, the stop synchronization function block is employed by the PLC 10 to remove that workpiece 16, 18 from the queue of the corresponding robot 14. Thus, the robot 14 is then available to begin synchronization with the next workpiece 16, 18 in the queue. Step S116 is performed by the PLC 10 based on at least one stop synchronization function block configured by a user.

Steps S102 to S110 are repeatedly performed by the PLC 10 to add workpieces to queues for robots 14. Steps S110 to S116 employ the queues generated in steps S102 to S110, and are also repeatedly performed by the PLC 10. Thus, while steps S102 to S110 result in a queue for the robots 14, steps S112 to S116 can be contemporaneously and independently performed while the queue is being generated and modified, so long as at least one workpiece 16, 18 is present in the queue. Also, as described above, a user can interact with the PLC 10 to interact directly with the queues, and perform step S110 manually. The user configures the PLC 10 via the application programming interface 106, and thus can define the operation of the function blocks employed in steps S112 and S116.

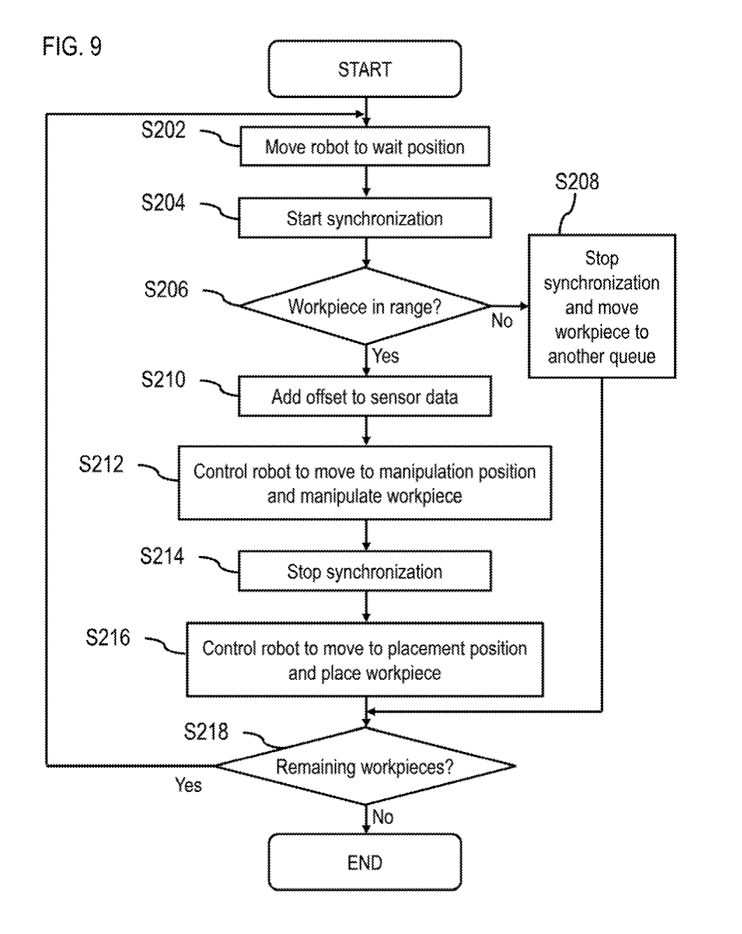

FIG. 9 provides another flowchart for programming robotic operations according to an embodiment of the present invention. The steps depicted in FIG. 9 provide further detail of the ability of the PLC 10 to control one or more robots 14 to manipulate workpieces 16, 18 in a queue. In the process depicted in the flowchart of FIG. 9, steps S202 to S218 provide further details of the operation of PLC 10 analogous to that of steps S112 to S116 described previously. At the start of the process prior to step S202, sensor data has been received as described with respect to step S102, and a queue has been generated for at least one robot 14 including at least one workpiece 16, 18 as described with respect to step S110.

As illustrated in FIG. 9, in step S202, a robot is moved to a wait position by the PLC 10. This wait position can provide a position proximate to an expected arrival point of a first workpiece of a queue, or a position near a base of the robot 14. Subsequently, in step S204, a start synchronization function block is employed to allow for tracking of a first workpiece at the top of the robot's queue. Step S204 can be performed as described above with respect to step S112.

In step S206, the PLC 10 compares a working range of the robot 14 to the present location of the workpiece 16, 18 which was the subject of the start of synchronization in step S204. If the workpiece 16, 18 is not in range the process continues to step S208. Step S208 is performed by the PLC 10 in accordance with a function block of the application programming interface 106. In step S208, a stop synchronization function block is employed to move the workpiece 16, 18, to the queue of another robot, and the process proceeds to step S218, which will be described in detail below. If the result of step S206 is affirmative, then the workpiece is found to be within range of the robot 14, and the process proceeds to step S210.

In step S210, an offset is added to the sensor data that is provided to the pick scheduler 104 via the sensor interface 102. Therefore, the target position for a robot 14 to move to manipulate the workpiece 16, 18 includes an offset that represents the motion of the workpiece 16, 18 as discussed previously. In step S212, the robot 14 is controlled by the PLC 10 to move to the manipulation position and perform the manipulation of the workpiece 16, 18.

In step S214, a stop synchronization function block of the application programming interface 106 is employed to cause the PLC 10 to remove the manipulated workpiece 16, 18 from the queue. In step S216, the workpiece 16, 18 is then placed in a placement position by moving the robot 14 to the placement position and releasing the workpiece 16, 18. The placement position can be a case, pallet, or conveyor, for example. The robot 14 is controlled by the PLC 10 to move the workpiece 16, 18 to the placement position in step S216.

In step S218 the PLC 10 determines if there are workpieces 16, 18 present in the queue. If this determination is affirmative, the process returns to step S202. If no workpieces 16, 18 remain in the queue, the process ends, and the PLC 10 causes robot 14 to wait until at least one workpiece 16, 18 is added to the queue for the robot 14 by pick scheduler 104.

The process depicted in FIG. 9 can be performed by multiple robots 14 under simultaneous control of one or more PLCs 10. Thus, each individual robot 14 of a plurality of robots 14 works independently according to a respective queue. If a workpiece 16, 18 is determined to be outside of a workable range of a particular robot 14, the workpiece 16, 18 is moved to the queue of another robot 14, such as an adjacent robot that is closer to the workpiece 16, 18 that was found to be out of range. Advantageously, each robot 14 operating according to the programming structure exemplified in FIG. 9 does not require complex programming in order to manipulate workpieces 16, 18 within range and share workflow with other robots 14. This improved efficiency, as well as other advantages, are achieved by decoupling of the queueing functions performed by pick scheduler 104 and the programming functions of the application programming interface 106. Thus, the flexible and modular nature of the pick scheduler 104 and the application programming interface 106 provide enhanced functionality of PLC 10. Alternatively, multiple robots 14 under simultaneous control of one or more PLCs 10 can operate entirely independently. In such a configuration, PLC 10 would not be configured to perform step S208. Rather, each robot 14 would operate independently according to the workpieces in its corresponding queue. Thus, the control of each robot 14 is not dependent on moving workpieces 16, 18 between queues.

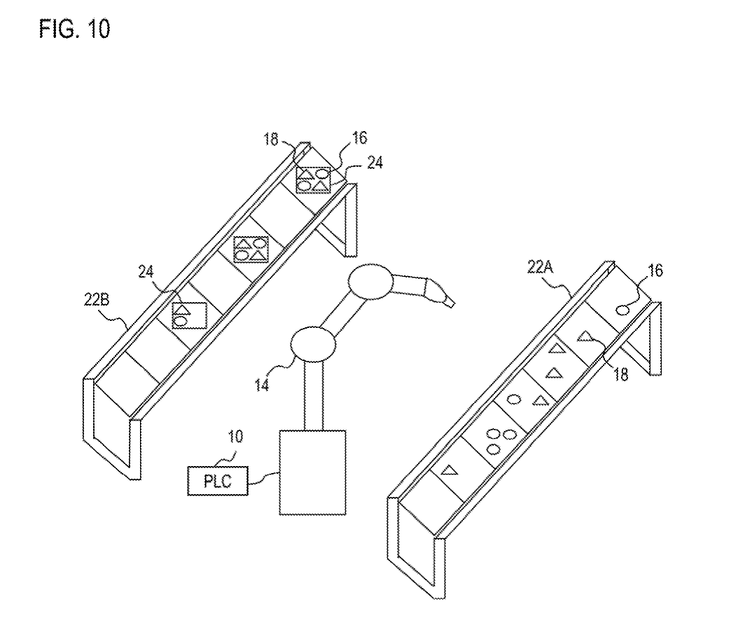

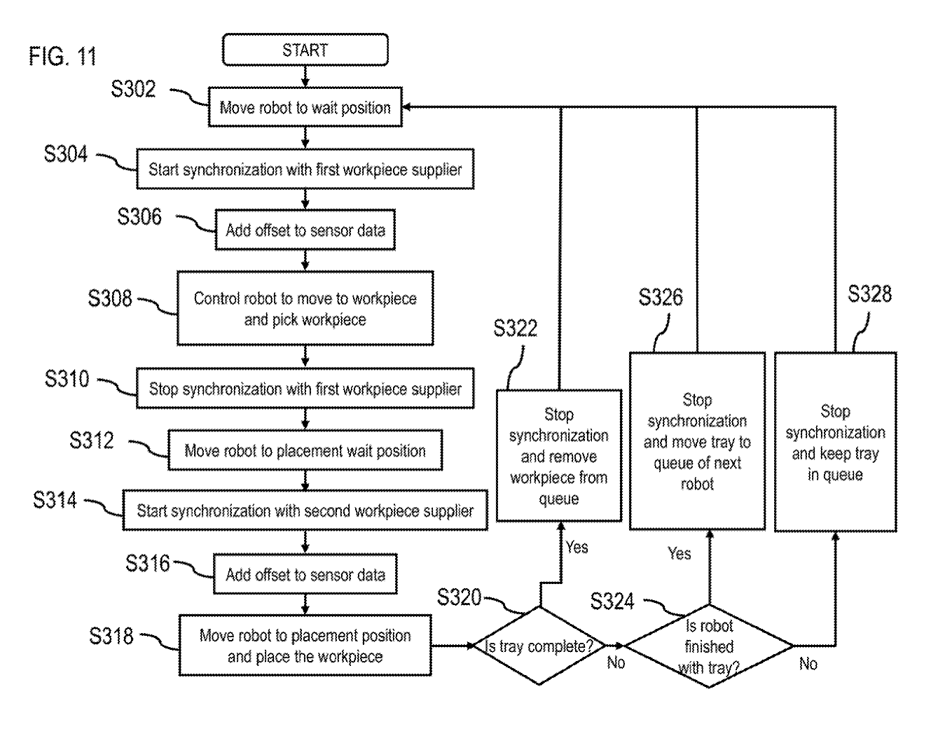

Another process according to an embodiment of the present invention will now be described with reference to FIGS. 10 and 11. FIG. 10 illustrates an exemplary system according to an embodiment of the present invention in which at least one robot 14 is employed to place a plurality of workpieces 16, 18, on a tray 24. In FIG. 10, two workpiece suppliers 22A and 22B are depicted. The workpiece suppliers 22A, 22B can provide motion to the workpieces 16, 18, or can be motionless. In the exemplary embodiment illustrated in FIG. 10, the workpiece suppliers 22A, 22B are conveyors. A first workpiece supplier 22A contains unsorted workpieces 16, 18. One or more robots 14 place workpieces 16, 18 on a tray 24 located on a second workpiece supplier 22B. For simplicity, sensor 12 is not depicted in FIG. 10. More than one sensor 12 can be employed in order to improve the accuracy of the workpiece tracking and identification. Plural sensors 12 are particularly useful when more than one workpiece supplier 22 is used, as in the case depicted in FIG. 10.

As depicted in FIG. 10, each tray 24 is a platform or box on which workpieces 16, 18 are placed. Tray 24 is located on second workpiece supplier 22B which accepts workpieces 16, 18 that have been picked from a first workpiece supplier 22A. Pick scheduler 104 performs queuing such that the generated queues include a tray 24 in addition to the individual workpieces 16, 18. While tray 24 is depicted in FIG. 10 and described with reference to FIG. 11, tray 24 can be replaced with a pallet, box, or other receptacle appropriate to receive one or more workpieces 16, 18. Alternatively, instead of a tray 24, robot 14 can combine a workpiece 16, 18 from first workpiece supplier 22A with one or more other objects to form an assembly that is then placed at a second location such as second workpiece supplier 22B.

FIG. 11 provides another flowchart for programming robotic operations. The functionality illustrated in FIG. 11 is particularly useful for systems that incorporate multiple workpiece suppliers 22, such as the exemplary system of FIG. 10. Steps in the flowchart of FIG. 11 that are the same as previously-described steps will not be described in detail.

First, as provided in step S302, robot 14 is moved to a wait position. This step can be performed by the PLC 10 as configured with a function block of the application programming interface 106. In step S304, synchronization with first workpiece supplier 22A is started by the PLC 10, in accordance with a start synchronization function block of application programming interface 106. Step S304 is performed when at least one workpiece is present in the queue of a robot 14. In step S306, offset data is added to sensor data.

In step S308, PLC 10 controls robot 14 to manipulate a workpiece 16, 18. For example, robot 14 moves to the workpiece 16, 18 and picks the workpiece 16, 18. Other manipulations, such as assembly, disassembly, pressing, welding, etc., can also be performed. Subsequently, in step S310, a stop synchronization function block of application programming interface 106 is employed to stop synchronization with first workpiece supplier 22A.

In step S312, the robot is moved to a placement wait position by the PLC 10. This step can involve carrying the workpiece 16, 18 that was picked in step S308 to a placement wait position, such as a position between first workpiece supplier 22A and second workpiece supplier 22B. In preparation for moving the workpiece to a placement position, in step S314, a start synchronization function block of application programming interface 106 is used to synchronize the robot 14 with the second workpiece supplier 22B. In step S316, offset data is added to the sensor data to provide accurate control over the motion of robot 14 relative to the second workpiece supplier 22B. Thus, the synchronization allows the picked workpiece 16, 18 to be moved with the robot 14 to a placement position in step S318. Step S318 can include placing a workpiece on a tray 24 located on the second workpiece supplier 22B, as illustrated in FIG. 10. The workpiece 16, 18 can be placed in a particular location specific to the individual workpiece 16, 18. Thus, the pick scheduler 104 and the application programming interface 106 can be employed to provide for specific picking and placement functionality solely through the use of PLC 10, without the need to program other devices.

After a workpiece 16, 18 is placed in step S318, the process proceeds to step S320 in which the PLC 10 determines if the tray 24 is complete. If the result is affirmative, synchronization with the second workpiece supplier 22B is stopped via application programming interface 106 in step S322. This can be performed by removing the placed workpiece 16, 18 from the queue for the robot 14 that placed the workpiece 16, 18 on the second workpiece supplier 22B. After step S322 is performed, the process returns to step S302.

If the result of the determination in step S320 is negative, the process proceeds to step S324, in which the PLC 10 determines if the robot 14 that placed the workpiece 16, 18 on the corresponding tray 24 is finished with the tray 24. If the answer to the determination in step S324 is affirmative, the tray 24 is incomplete and the robot 14 that placed the workpiece 16, 18 on the tray 24 does not have additional work to perform on the tray 24. Therefore, in step S326, synchronization with tray 24 and second workpiece supplier 22B is stopped and tray 24 is moved to the queue of the next robot 14 by application programming interface 106. Thus, the next robot will perform work as to complete the tray 24 as necessary. The process then proceeds to step S302, in which the PLC 10 moves the robot 14 that placed the workpiece 16, 18 on tray 24 to the wait position again.

If the determination in step S324 is negative, the robot 14 that placed the workpiece 16, 18 on the tray 24 has additional work to perform on the tray 24. This additional work can include placement of one or more additional workpieces on the tray 24. The process therefore proceeds to step S328 where the PLC 10, in accordance with application programming interface 106, stops synchronization with the tray 24 and second workpiece supplier 22B but keeps the tray in the queue of the robot 14. The process then returns to step S302.

As illustrated in the foregoing examples, the cooperative action of the sensor interface 102, the pick scheduler 104, and the application programming interface 106 of the PLC 10 provide for extensive programming and configuration. By interfacing with PLC 10 by at least one of a personal computer 32, input device 34, and a display 36, a user can program a single device, the PLC 10, and control the motions of multiple robots 14 in applications ranging from simple to complex.

All configuration, programming, and adjustment necessary to achieve a desired operation of one or more robots can be performed inside a PLC environment. As there is no need to perform programming on intermediate devices such as a motion controller, or program individual robots, the present invention allows a user to configure and program operations of a plurality of robots without the need to learn additional programming languages. The ability to interact with only PLC 10 also simplifies the components required, facilitating installation, set up, and troubleshooting. Furthermore, by decoupling the operation of a robot from the sensor simplifies the process of configuring the PLC 10.

It should be noted that the exemplary embodiments depicted and described herein set forth the preferred embodiments of the present invention, and are not meant to limit the scope of the claims hereto in any way. Numerous modifications and variations of the present invention are possible in light of the above teachings. It is therefore to be understood that, within the scope of the appended claims, the invention can be practiced otherwise than as specifically described herein.

What is claimed is:

1. A programmable logic controller for controlling at least one robot to manipulate a plurality of workpieces, the programmable logic controller comprising:
a sensor interface configured to receive sensor data representing information of the workpieces;
a scheduler configured to create a schedule including information representing an order in which the workpieces are to be manipulated based on the sensor data; and
a synchronizer configured to cause a robot to manipulate the workpieces based on the schedule and at least one function block, the at least one function block being configured with the programmable logic controller.

2. The programmable logic controller according to claim 1,
wherein the scheduler is configured to create a respective schedule for each of a plurality of robots including the robot, and
wherein the synchronizer is configured to control the robots to manipulate the workpieces based on the schedules.

3. The programmable logic controller according to claim 1,
wherein the scheduler is configured to create a respective schedule for each of a plurality of robots including the robot, and
wherein the scheduler is configured to create the schedules by unevenly assigning the workpieces to the robots.

4. The programmable logic controller according to claim 1,
wherein the scheduler is configured to create a respective schedule for each of a plurality of robots including the robot, and
wherein the scheduler is configured to create the schedules by assigning the workpieces to the robots in a repeating pattern according to a sequence in which the workpieces are disposed.

5. The programmable logic controller according to claim 1,
wherein the scheduler is configured to create a respective schedule for each of a plurality of robots including the robot, and
wherein the scheduler is configured to receive input from a user via an input device such that the schedules are created or modified according to a user-provided criterion.

6. The programmable logic controller according to claim 1,
wherein the scheduler is configured to create a respective schedule for each of a plurality of robots including the robot,
wherein the sensor data includes information identifying a type of each of the workpieces, and
wherein the scheduler is configured to create the schedules by assigning the workpieces to one or more corresponding robots based on the type of the workpiece identified in the sensor data.

7. The programmable logic controller according to claim 6, wherein the sensor interface is configured to receive sensor data from a vision sensor to create the sensor data that includes information identifying the type of each of the workpieces.

8. The programmable logic controller according to claim 1,
wherein the synchronizer includes a programming interface configured to provide the at least one function block by which a user can provide an instruction, and
wherein the synchronizer controls the robot to manipulate at least one of the workpieces in accordance with the instruction provided with the at least one function block.

9. The programmable logic controller according to claim 8, wherein the synchronizer is configured to control the robot to compensate for a movement of the first workpiece on a workpiece supplier that imparts motion to the workpiece when the robot is in operation.

10. The programmable logic controller according to claim 8,
wherein the programmable logic controller is configured to control a plurality of robots and create a respective schedule for each of the robots, and
wherein modifying the schedule by the programming interface includes moving a first workpiece from the schedule of a first robot of the robots to the schedule of a second robot of the robots.

11. The programmable logic controller according to claim 10, wherein the synchronizer is configured to move the first workpiece from the schedule of the first robot to the schedule of the second robot based on a determination that the first workpiece is outside of a working range of the first robot.

12. The programmable logic controller according to claim 1,
wherein the synchronizer includes a programming interface configured to provide the at least one function block to a user, and
wherein the at least one function block synchronizes a movement of the robot with a movement of a workpiece supplier.

13. A programmable logic controller for controlling at least one robot to manipulate a plurality of workpieces, the programmable logic controller comprising circuitry configured to:
receive sensor data representing information of a plurality of workpieces to be manipulated by a robot;
create a schedule including information representing an order in which the workpieces are to be manipulated based on the sensor data; and
receive the schedule and thereafter control the robot to manipulate the workpieces based on the schedule and at least one function block, the at least one function block being configured with the programmable logic controller.

14. The programmable logic controller according to claim 13, further comprising circuitry configured to:
control a plurality of robots including the robot and create a respective schedule for each of the robots; and
create the schedules for each of the robots by unevenly assigning the workpieces to the robots.

15. The programmable logic controller according to claim 13, further comprising circuitry configured to:
control a plurality of robots and to create a respective schedule for each of the robots; and
create the schedules by assigning the workpieces to one or more corresponding robots based on the type of the workpiece identified in the sensor data when the sensor data includes information identifying a type of each of the workpieces.

16. The programmable logic controller according to claim 13, further comprising circuitry configured to:
provide the at least one function block to a user by which the user can provide an instruction; and
control the robot to manipulate at least one of the workpieces in accordance with the instruction provided with the at least one function block.

17. A system for manipulating a plurality of workpieces, the system comprising:
a sensor;
a first robot;
a second robot; and
a programmable logic controller for controlling the first robot and the second robot, the programmable logic controller including:
a sensor interface configured to receive sensor data from the sensor representing location information of the workpieces;
a scheduler configured to create a schedule including information representing an order in which the workpieces are to be manipulated based on the sensor data; and
a synchronizer configured to cause at least one of the first robot and the second robot to manipulate the workpieces based on the schedule and at least one function block, the at least one function block being configured with the programmable logic controller.

18. The system according to claim 17,
wherein the scheduler is configured to create a respective schedule for the first robot and the second robot, and
wherein the scheduler is configured to create the schedules by unevenly assigning the workpieces to the first robot and the second robot.

19. The system according to claim 17,
wherein the scheduler is configured to create a respective schedule for the first robot and the second robot,
wherein the sensor data includes information identifying a type of each of the workpieces, and
wherein the scheduler is configured to create the schedules by assigning the workpieces to the first robot and the second robot based on the type of the workpiece identified in the sensor data.

20. The system according to claim 17,
wherein the synchronizer includes a programming interface configured to provide at least one function block to a user, and
wherein the at least one function block synchronizes a movement of the at least one of the first robot and the second robot with a movement of a workpiece supplier.

21. A method of controlling at least one robot to manipulate a plurality of workpieces with a programmable logic controller, the method comprising:
receiving sensor data representing location information of the workpieces;
creating a schedule including information representing an order in which the workpieces are to be manipulated based on the sensor data; and
controlling a robot to manipulate the workpieces based on the schedule and at least one function block, the at least one function block being configured with the programmable logic controller.

22. The method according to claim 21, further comprising:
creating respective schedules for each of a plurality of robots including the robot by unevenly assigning the workpieces to the robots; and
controlling the robots according to the schedules.

23. The method according to claim 21,
wherein the sensor data includes information identifying a type of each of the workpieces,
the method further comprising creating respective schedules for each of a plurality of robots including the robot based on the type of the workpiece identified in the sensor data.

24. The method according to claim 21, further comprising providing at least one function block that is operable to synchronize a movement of the robot with a movement of a workpiece supplier to a user.
